(19) United States
(12) Patent Application Publication
(10) Pub. No.: US 2004/0055360 A1
(43) Pub. Date: Mar. 25, 2004

(54) Device for reducing wear of ink strips in a position sensor

(76) Inventors: Russell Miles Modien, Chatham (CA); Kenneth Peter Nydam, Chatham (CA)

Correspondence Address: Siemens Corporation, Intellectual Property Department, 186 Wood Avenue South, Iselin, NJ, 08830, US

(21) Appl. No.: 10/251,051

(22) Filed: Sep. 20, 2002

(51) Int. Cl. G01B 7/00; G01B 5/00; G 01B 1 1/33

(52) U.S. Cl. 73/1.79; 324/699; 324/601

(57) ABSTRACT

A slider assembly for use in a linear or rotary position sensor having a board that includes at least one ink strip. The slider assembly includes a housing for attachment to an object whose position is being detected. The housing includes standoffs for contacting portions of the board which are adjacent the ink strip. An arm extends the housing, wherein the arm includes finger elements which contact the ink strip. The assembly further includes a spring for biasing the standoffs against the board to then bias the finger elements against the ink strip so as to provide a predetermined contact pressure.

### FIELD OF THE INVENTION

This invention relates to linear and rotary position sensors, and more particularly, to a slider assembly having a slider housing which includes standoffs for providing a predetermined contact pressure between spring fingers and an ink strip.

### BACKGROUND OF THE INVENTION

Several devices utilized in motor vehicles include components that wear after repeated use. A device having such components is a contact position sensor that detects the position of an object such as an armature. Referring to FIG. 1, portions of a linear position sensor 10 having a slider assembly 12 is shown. The slider assembly 12 is positioned adjacent a board 32 having first 28 and second 30 ink strips which may be resistive inks used in forming a sensing circuit for detecting position. In another configuration, one of the ink strips may be conductive and the other resistive.

The slider assembly 12 includes a base 14 and a plunger 16 that is adapted to be received by an armature. The base 14 includes a center member 18 located between first 20 and second 22 arms which extend outwardly from the base 14 to form a substantially U-shaped configuration. The first 20 and second 22 arms include first 24 and second 26 finger elements which are adapted to contact the first 28 and second 30 ink strips, respectively, so as to form electrical contact. In use, the first 24 and second 26 finger elements move across the first 28 and second 30 ink strips in accordance with corresponding armature movement. This provides an output, such as a voltage output, which is proportional to the relative position of the first 24 and second 26 finger elements with respect to the first 28 and second 30 ink strips.

The first 20 and second 22 arms and first 24 and second 26 finger elements are fabricated from a resilient material having spring properties. The slider assembly 12 is positioned relative to the board 32 such that the first 24 and second 26 finger elements exert a spring force for biasing the first 24 and second 26 finger elements against the first 28 and second 30 ink strips. This provides a predetermined contact pressure suitable for minimizing wear of the first 28 and second 30 ink strips.

During typical motor vehicle operation the slider assembly 12 is frequently subjected to vibrations which are of sufficient magnitude to overcome the spring force exerted by the first 24 and second 26 finger elements. This substantially increases the frequency with which the first 24 and second 30 spring elements move across portions of the first 28 and second 30 ink strips, thus increasing relative motion therebetween and causing accelerated wear of the first 28 and second 30 ink strips. A method for reducing the relative motion is to increase the spring force exerted by the first 24 and second 26 finger elements on the first 28 and second 30 ink strips. However, this results in an increased ink wear rate due to increased finger element contact pressure. Another method is to use more stringent mechanical clearances when fabricating the sensor. A disadvantage with this approach is that manufacturing costs are increased. In addition, further control of relative motion is desired in order to reduce the ink wear rate and ultimately increase the reliability of such sensors.

### SUMMARY OF THE INVENTION

A slider assembly for use in a position sensor having a board that includes at least one ink strip. The slider assembly includes a housing for attachment to an object whose position is being detected. The housing includes standoffs for contacting portions of the board which are adjacent the ink strip. An arm extends the housing, wherein the arm includes finger elements which contact the ink strip. The assembly further includes a spring for biasing the standoffs against the board to then bias the finger elements against the ink strip so as to provide a predetermined contact pressure.

The features of the invention believed to be novel are set forth with particularity in the appended claims. The invention itself, however, both as to organization and method of operation, may be best understood by reference to the following description taken in conjunction with the accompanying figures.

### BRIEF DESCRIPTION OF THE DRAWINGS

FIG. 1 is a perspective view of portions of a linear position sensor.

FIG. 2 is a side view of slider assembly in accordance with the present invention.

### DETAILED DESCRIPTION OF THE INVENTION

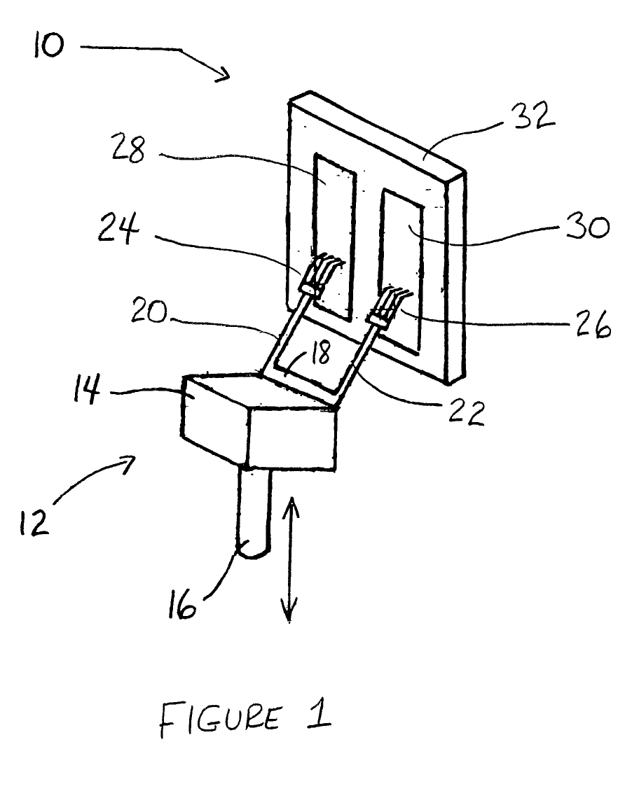

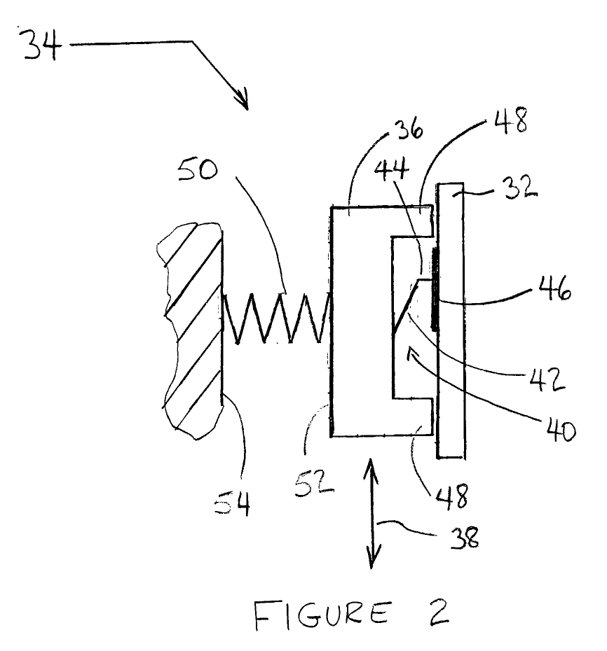

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of FIGS. 1-2.

Referring to FIG. 2, a side view of a slider assembly 34 for use in a position sensor in accordance with the present invention is shown. The slider assembly 34 includes a slider housing 36 that is adapted to be connected to an object whose position is to be detected, such as an armature, which moves as depicted by arrow 38. The slider assembly 36 includes at least one contactor 40 that extends toward the board 32. The contactor 40 includes a spring arm 42 and spring fingers 44 which are formed on an end of the spring arm 42. The spring fingers 44 contact an associated ink strip 46 so as to form electrical contact as part of a position sensing circuit. The spring arm 42 and spring fingers 44 are fabricated from a resilient material to enable biasing of the spring fingers 44 against the ink strip 46. In use, the spring fingers 44 move across the ink strip 46 in accordance with corresponding armature movement. This provides an output, such as a voltage output, which is proportional to the relative motion of the spring fingers 44 with respect to the ink strip 46.

The slider housing 36 includes legs or standoffs 48 which are adapted to contact portions of the board 32 adjacent to the ink strip 46. The standoffs 48 are sized such that the spring fingers 44 are biased against the ink strip 46 to provide a predetermined contact pressure. A spring 50 is located between a back surface 52 of the slider housing 36 and a surface of a sensor housing 54. The spring 50 is adapted to move in conjunction with the slider assembly 34, and may be located in a channel formed in the sensor housing 54, for example. The spring 50 is configured to exert a force against the slider housing 36 to bias the standoffs 48 against the board 32 to thus bias the spring fingers 44 against the ink strip 46 so as to provide the predetermined contact pressure. The spring 50 enables the slider assembly 34 to be free floating, thus substantially isolating the spring fingers 44 from vibrations which occur during typical motor vehicle operation. In addition, this arrangement substantially reduces the need for highly precise alignment of the slider assembly 34, thus enabling the use of less stringent mechanical tolerances when fabricating the sensor.

While the invention has been described in conjunction with specific embodiments, it is evident that many alternatives, modifications, permutations and variations will become apparent to those skilled in the art in light of the foregoing description. It is noted that the present invention may be used in either linear or rotary position sensors, although it may be more adaptable to rotary arrangements. Accordingly, it is intended that the present invention embrace all such alternatives, modifications and variations as fall within the scope of the appended claims.

What is claimed is:

1. A slider assembly for use in a position sensor having a board that includes at least one ink strip, comprising:
a housing for attachment to an object whose position is being detected, said housing including standoffs for contacting portions of said board adjacent said ink strip;
an arm extending from said housing, said arm including finger elements which contact said ink strip; and
a spring for biasing said standoffs against said board to bias said finger elements against said ink strip to provide a predetermined contact pressure.

2. The slider assembly according to claim 1, wherein said sensor is a linear position sensor.

3. The slider assembly according to claim 1, wherein said sensor is a rotary position sensor.

4. A method for not exceeding a predetermined contact pressure between spring fingers and an ink strip formed on a board used in a position sensor, comprising the steps of:
providing a slider housing which includes a contactor arm having spring fingers for contacting said ink strip, said slider housing further including standoffs sized to provide a predetermined contact pressure between said spring fingers and said ink strip when said standoffs contact said board; and
biasing said standoffs against said board to bias said finger elements against said ink strip to provide a predetermined contact pressure.

4. The method according to claim 3, wherein said sensor is a linear position sensor.

5. The method according to claim 3, wherein said sensor is rotary position sensor.
